(19) United States
(12) Patent Application Publication
(10) Pub. No.: US 2023/0398715 A1
(43) Pub. Date: Dec. 14, 2023

(54) IMPROVED USE OF MDI IN ENGINEERED WOOD PRODUCTS

(71) Applicant: Smartech The Industry Pivot Ltd., Caesarea (IL)

(72) Inventors: Irina Glazer, Kfar Blum (IL); Amnon Shoshani, Givat-Ada (IL)

(73) Assignee: Smartech The Industry Pivot Ltd., Caesarea (IL)

(21) Appl. No.: 18/250,226

(22) PCT Filed: Oct. 19, 2021
(86) PCT No.: PCT/IB2021/059621

§ 371 Date: Apr. 24, 2023

Related U.S. Application Data
(60) Provisional application No. 63/105,311, filed on Oct. 25, 2020.

(51) Int. Cl. B27N 3/18; B27N 1/02; B27N 3/00

(52) U.S. Cl. CPC B27N 3/18; B27N 1/0209; B27N 3/002; B27N 1/029

(57) ABSTRACT

A method for forming an engineered wood product includes grinding an MDI (methylene diphenyl di-isocyanate) binder together with water in a grinder to form a ground MDI dispersion. The ground MDI dispersion is fed into a wood production machine in which are lignocellulosic materials. The lignocellulosic materials are bound together by the ground MDI dispersion to form an engineered wood product.

### FIELD OF THE INVENTION

The present invention relates generally to adhesive binders in wood products, and particularly to improvements in the use of MDI in engineered wood products.

### BACKGROUND OF THE INVENTION

Binders for bonding wood are used in the manufacture of engineered wood products such as oriented strand board (OSB), flake board, particleboard, veneer, medium density fiberboard (MDF), high density fiberboard (HDF) and other products. The cost of the binders is a very significant part of the cost of the process or product. Accordingly, it is very desirable to decrease the cost or increase the effectivity of the binder, which will reduce the cost and/or consumption and improve the performance of the wood product and of the wood production process including faster press times.

There are problems with different kinds of binders (adhesives, the terms being used interchangeably). For example, adhesive formulations comprising a combination of urea and formaldehyde structures or a combination of phenol and formaldehyde structures lead to the release of formaldehyde, a regulated chemical designated by the US National Toxicology Program as “known to be a human carcinogen.”

Another binder is methylene diphenyl di-isocyanate (MDI). MDI resins are used in the production of engineered wood products, such as OSB, MDF, particleboard and lightweight wood fiber insulation products. MDI is a versatile and efficient binder which provides a supreme bond with the wood particles or strands as it has a reaction with the wood itself when put under intense heat. MDI resins generally form chemical bonds as opposed to mechanical bonds formed with formaldehyde-based resins. MDI bonds by forming a diffusion interphase in which the resin spreads over the surface of the wood and penetrates into cracks, cell lumen and even cell walls.

### SUMMARY

The present invention seeks to provide an improved system and method for using MDI resin in making engineered wood products, as is described more in detail hereinbelow. The MDI is ground into small particles, such as but not limited to, less than 200 μm, alternatively less than 100 μm, alternatively less than 50 μm, alternatively less than 10 μm, or alternatively less than 5 μm, to form a MDI dispersion. It has been surprisingly found that the grinding significantly improves the performance and properties of the MDI and of the finished engineered wood product and reduces costs of the process.

There is thus provided in accordance with an embodiment of the present invention a method for forming an engineered wood product including grinding an MDI (methylene diphenyl di-isocyanate) binder together with water in a grinder to form a ground MDI dispersion, and feeding the ground MDI dispersion into a wood production machine in which are lignocellulosic materials, wherein the lignocellulosic materials are mixed and bound together by the ground MDI dispersion to form an engineered wood product.

In accordance with an embodiment of the present invention the MDI binder is ground with one or more water additives.

In accordance with an embodiment of the present invention the MDI binder is ground with one or more binder additives.

In accordance with an embodiment of the present invention the MDI binder is pre-ground in a pre-grinder before grinding in the grinder.

In accordance with an embodiment of the present invention the MDI binder and/or the water are pre-heated or pre-cooled before the grinding.

In accordance with an embodiment of the present invention an amount of the ground MDI dispersion in the engineered wood product is about 0.5 to 25 wt % based on final product weight.

In accordance with an embodiment of the present invention a controller controls an operational parameter of the method. The controller may be coupled to one or more sensors in a feedback control loop.

### BRIEF DESCRIPTION OF THE DRAWINGS

The present invention will be understood and appreciated more fully from the following detailed description, taken in conjunction with the drawing in which:

FIG. 1 is a simplified block diagram of a system for preparing an MDI dispersion for use in production of engineered wood products, in accordance with a non-limiting embodiment of the present invention.

### DETAILED DESCRIPTION OF EMBODIMENTS

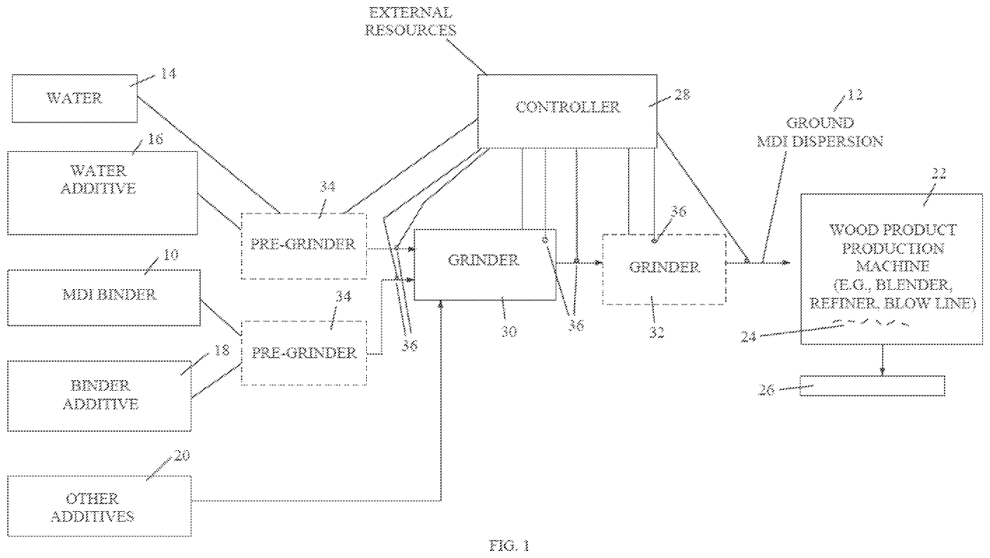

In the illustrated embodiment of FIG. 1, MDI binder 10 is ground together with other materials in a grinder 30 (and optionally one or more other grinders 32) to form ground MDI dispersion 12. The ground MDI dispersion 12 may include, without limitation, water 14, one or more optional water additives 16, such as but not limited to, fire extinguishing substances or biocides, one or more optional binder additives 18, such as but not limited to, fire extinguishing substances or biocides, surfactants, and other additives 20. Additives may be in liquid or solid form and may be soluble or non-soluble. One or more of these ingredients may be pre-ground in one or more pre-grinders 34 or added to the water or the resin before grounding.

Thus, the MDI binder 10 may be pre-ground together with the additives. Alternatively, the additives may be pre-ground with the water. The additives may be water soluble or binder soluble, or may not be soluble, and may be liquid or solid (e.g., powder).

The ground MDI dispersion 12 is fed into a wood production machine 22, in any place before the formation of the wood product 26. One non limiting example is feeding a blender, a rotary drum blender, a blow line or another type of blending device, in which lignocellulosic materials 24 are bound together by the ground MDI dispersion 12 to form an engineered wood product 26.

The term “engineered wood product” encompasses wood-containing materials, including, but not limited to, chipboard, fiber board, flake board, laminated-strand lumber, oriented strand board (OSB), medium density fiberboard (MDF), high density fiberboard (HDF), parallel-strand lumber, particle board, plywood, veneer, wafer board and others.

The term “lignocellulosic material” encompasses pieces of wood used to make engineered wood products and includes, but is not limited to, wood strands, wood particles, wood plies, wood fibers, wood chips and others.

The term “MDI” or “MDI binder” (used interchangeably) is defined as any resin prepared from methylene diphenyl di-isocyanate, such as but not limited to, 4, 4′-methylene diphenyl di-isocyanate, and includes PMDI.

The term “grind” encompasses (in all its inflections), grind, crush, mill, disintegrate, pulverize, chop, cut, slice and other methods of reducing size of particles.

The term “dispersion” encompasses suspension, emulsion, dispersion, solution and others.

According to a non-limiting embodiment, the amount of ground MDI dispersion 12 in the engineered wood product 26 may be, without limitation, about 1 to 10 wt % based on the final product weight.

A controller 28 may be coupled to the grinders 30 and 32 (and pre-grinders 34) and to one or more sensors 36 (in a feedback control loop) for controlling every operational parameter of the process, such as but not limited to, temperature, viscosity, density, flow rate, mass flow rate, chemical composition, and others (the sensors 36 being sensors for these parameters). The controller 28 can receive feedback from other elements along the production line, such as from the press, and can transmit operational commands to any element along the production line in accordance with data from the grinding or other process.

Grinding reduces size of water and/or binder particles and also improves the chemical properties, such as but not limited to, the reactivity of the dispersion in comparison with known reactivity of the prior art. This gives the dispersion much better bonding and performance properties, better distribution of MDI particles, and more long-lasting stability than merely mixing. Grinding reduces the amount of lost water in the process, since the water is trapped in the MDI particles or the MDI particles are trapped in the water, and creates an improved water-binder reaction. The dispersion is used shortly after its creation and well within the pot life of the MDI. The MDI dispersion is broken into small droplet particles. The water is trapped in the MDI droplets and will not react with water external to the droplets.

It is noted that the invention encompasses both water droplets in the binder and binder droplets in the water.

In systems that use nozzles, the ground MDI mixture can flow to multiple nozzles and to multiple blenders and is ready for immediate use. The grinding apparatus is external to the wood processing blenders. The ground MDI mixture is suitable for use with atomizers and is not sensitive to blockages or other occlusions in the line. The process is not sensitive to changes in flow rates. The grinders can be cooled or heated to a desired temperature which may be different from room temperature, MDI storage temperature or MDI mixture temperature. Every parameter of the process can be controlled with sensors and feedback to adapt to changing conditions in the process. The MDI spreads more evenly and uniformly in the wood production machine 22. There is better control on the chemical properties such as reactivity of the MDI and thus there is better performance and effectiveness.

The invention decreases the amount of MDI needed per given area (without limitation, a decrease of about 20% in comparison with the prior art) and increases the effectivity of the MDI and controls its chemical properties such as reactivity.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

What is claimed is:

1. A method for forming an engineered wood product comprising:
grinding an MDI (methylene diphenyl di-isocyanate) binder together with water in a grinder to form a ground MDI dispersion; and
feeding said ground MDI dispersion into a wood production machine in which are lignocellulosic materials, wherein said lignocellulosic materials are bound together by said ground MDI dispersion to form an engineered wood product.

2. The method according to claim 1, wherein said MDI binder is ground with one or more water additives.

3. The method according to claim 1, wherein said MDI binder is ground with one or more binder additives.

4. The method according to claim 1, wherein said MDI binder is pre-ground in a pre-grinder before grinding in said grinder.

5. The method according to claim 1, wherein an amount of said ground MDI dispersion in said engineered wood product is about 0.5 to 25 wt % based on final product weight.

6. The method according to claim 1, further comprising using a controller to control an operational parameter of the method.

7. The method according to claim 6, further comprising using a controller to control an operational parameter of the method, said controller being coupled to one or more sensors in a feedback control loop.

8. The method according to claim 1, further comprising cooling said grinder to below room temperature.

9. The method according to claim 1, further comprising heating said grinder to above room temperature.

10. An engineered wood product made by the method of claim 1.
